(19) United States
(12) Patent Application Publication
(10) Pub. No.: US 2023/0408033 A1
(43) Pub. Date: Dec. 21, 2023

(54) CRYOGENIC TANK-FILLING ARRANGEMENT AND METHOD

(71) Applicants: Linde GmbH, Pullach (DE); Butting CryoTech GmbH, Burgkirchen (DE)

(72) Inventors: Florian EHEGARTNER, Pullach (DE); Bernhard REITER, Grabenstätt (DE)

(21) Appl. No.: 18/247,700

(22) PCT Filed: Oct. 1, 2021
(86) PCT No.: PCT/EP2021/025377

§ 371 Date: Apr. 3, 2023

(30) Foreign Application Priority Data
Oct. 2, 2020 (EP) 20020450.1

(51) Int. Cl. F17C 5/02

(52) U.S. Cl. CPC F17C 5/02; F17C 2223/0161; F17C 2205/037; F17C 2221/012; F17C 2270/0168; F17C 2265/065

(57) ABSTRACT

A cryogenic tank-filling arrangement having a coupling device and a receptacle, wherein the coupling device and the receptacle are designed to be complementary to each other, wherein the cryogenic tank-filling arrangement can be brought with the aid of a pressure change in the intermediate space from an unlocked state—in which the coupling device and the receptacle are accommodated in each other at least in sections, so that the coupling device and the receptacle enclose an intermediate space which is closed off relative to an environment of the cryogenic tank-filling arrangement and which is arranged between an end face of the coupling device and an end face of the receptacle—into a locked state, in which the end face of the coupling device is pressed against the end face of the receptacle due to the pressure change.

The invention relates to a cryogenic tank-filling arrangement and a method for operating such a cryogenic tank-filling arrangement.

A cryogenic tank-filling arrangement comprises a storage tank which can be coupled to a storage tank of a vehicle with the aid of a tank-filling hose or pipe, a coupling device provided on the tank-filling hose or pipe, and a receptacle provided on a vehicle so that the vehicle can be refueled with cryogenic media, such as, for example, hydrogen. The coupling device is locked onto the receptacle by means of a locking device. This locking takes place manually, so that an unlocking thereof is also possible only manually. In an emergency, e.g., in the event of a leak, this can lead to the locking no longer being safely releasable.

Against this background, it is an object of the present invention to provide an improved cryogenic tank-filling arrangement.

Accordingly, a cryogenic tank-filling arrangement having a coupling device and a receptacle is proposed. The coupling device and the receptacle are here designed to be complementary to each other, wherein the cryogenic tank-filling arrangement can be brought from an unlocked state—in which the coupling device and the receptacle are accommodated in each other at least in sections, so that the coupling device and the receptacle enclose an intermediate space which is closed off relative to an environment of the cryogenic tank-filling arrangement and which is arranged between an end face of the coupling device and an end face of the receptacle—into a locked state by means of a pressure change in the intermediate space, in which locked state the end face of the coupling device is pressed against the end face of the receptacle due to the pressure change.

In one development, a cryogenic tank-filling arrangement having a coupling device and a receptacle is proposed. In this case, the cryogenic tank-filling arrangement can, with the aid of a pressure change in the intermediate space, be brought from an unlocked state—in which the coupling device is accommodated in the receptacle in such a way that an intermediate space closed off from an environment of the cryogenic tank arrangement is provided between the coupling device and the receptacle—into a locked state in which the coupling device is pressed against the receptacle due to the change in pressure.

Because the cryogenic tank-filling arrangement can be brought into the locked state from the unlocked state with the aid of the pressure change in the intermediate space, manual unlocking can be dispensed with. By applying pressure to the intermediate space, the coupling device can be simply and automatically disconnected from the receptacle or ejected therefrom.

The cryogenic tank-filling arrangement can also be referred to as a cryogenic refueling arrangement. The coupling device can also be referred to as a coupling, a hydrogen coupling device, or a hydrogen coupling. The coupling device is suitable for being accommodated in the receptacle of a vehicle for the purpose of refueling the vehicle. A tank hose is assigned to the coupling device. The tank hose can be part of the coupling device. In the unlocked state, the coupling device is accommodated in particular far enough into the receptacle that the intermediate space is provided at the end faces between the coupling device and the receptacle. Conversely, in the unlocked state, the receptacle can also be accommodated in the coupling device. In order to bring the cryogenic tank-filling arrangement from the unlocked state into the locked state, a vacuum or negative pressure is preferably applied to the intermediate space. This pressure change causes a force which pulls the coupling device and the receptacle together.

As long as the cryogenic tank-filling arrangement is in the unlocked state, the coupling device can be pulled out of the receptacle. Only by application of the pressure change to the intermediate space is the cryogenic tank-filling arrangement brought into the locked state. In the locked state, the vacuum prevents the coupling device from independently detaching from the receptacle. The force generated by the pressure change thus locks the coupling device in the receptacle. In the unlocked state, the coupling device seals in a fluid-tight manner against the receptacle so that the intermediate space is separated from the environment.

In the present case, the fact that the pressure change “presses” the coupling device against the receptacle means that the coupling device and the receptacle are pressed against each other with a force. What is meant by “due to pressure” or “due to the force generated by the pressure” is in particular that the pressure change or the acting force in the now closed gap is the cause of the coupling device being pressed against the receptacle. In the locked state, the intermediate space is preferably closed. That is to say, in the locked state, the intermediate space is no longer present. In particular, when viewed along an axial direction, the coupling device is pressed or pressed against the receptacle with the aid of the force caused by the pressure change. In the present case, a “pressure change” is preferably to be understood as a pressure reduction, and in particular the generation of a vacuum.

The fact that the coupling device and the receptacle are “complementary” to each other means in particular in the present case that the coupling device and the receptacle can be plugged into each other in the manner of a plug-in connection. For this purpose, the coupling device and the receptacle each have a similarly shaped geometry which allows such insertion into each other. For example, the coupling device has a cylindrical geometry, and the receptacle has a complementary, hollow-cylindrical geometry. In this case, either the coupling device can be inserted into the receptacle or the receptacle can be inserted into the coupling device.

In the present case, “accommodate” can be understood to mean, in particular, “insert” or “plug into each other.” For example, the coupling device can be designed to be male and the receptacle female, or vice versa. “Male” in the present case means, with reference to the coupling device, that the coupling device is suitable for being accommodated in the receptacle. “Female” means in the present case, with reference to the receptacle, that the receptacle is suitable for accommodating the coupling device. The fact that the coupling device and the receptacle are “accommodated in each other” can in the present case mean in particular that either the coupling device is accommodated in the receptacle or, vice versa, that the receptacle is accommodated in the coupling device.

The intermediate space is preferably delimited or enclosed by the two end faces and a circumferential receiving section which is provided on the coupling device or on the receptacle. The intermediate space is in particular closed off in a fluid-tight, and preferably gas-tight, manner with respect to the environment. In the present case, “fluid-tight” means that not only can no fluid escape from the intermediate space into the environment, but also that no fluid can enter the intermediate space from the environment. In the locked state, the first end face and the second end face abut each other—in particular, so as to be flat. In this case, “flat” means with as large an area as possible, and is to be seen in contrast to a linear contact or a point contact. The first end face can also be referred to as the first end. Accordingly, the second end face can be referred to as the second end.

According to one embodiment, the coupling device has a counter-receiving section, wherein the receptacle has a receiving section complementary to the counter-receiving section, and wherein the counter-receiving section is accommodated at least in sections in the receiving section not only in the unlocked state but also in the locked state.

Conversely, the counter-receiving section can also be provided on the receptacle and the receiving section on the coupling device.

According to a further embodiment, the counter-receiving section and the receiving section are in each case cylindrical.

In particular, the counter-receiving section and the receiving section are each hollow-cylindrical in shape. In this case, the counter-receiving section can be accommodated in the receiving section. The counter-receiving section and the receiving section can also in each case be polygonal, e.g., hexagonal, or star-shaped.

According to a further embodiment, the first end face and the second end face are in each case annular.

In the present case, “annular” is to be understood to mean that the first end face and the second end face are in each case circumferentially closed. As mentioned above, the end faces can also be referred to as ends or are ends.

According to a further embodiment, the first end face is provided on a housing of the coupling device, wherein the second end face is provided on a housing of the receptacle.

This means in particular that, in the locked state, the housing of the coupling device and the housing of the receptacle abut each other.

According to a further embodiment, in the locked state, an end face of the coupling device abuts an end face of the receptacle, wherein, in the unlocked state, the intermediate space is arranged between the end face of the coupling device and the end face of the receptacle.

In the locked state, the end faces are pressed against each other.

According to a further embodiment, the receptacle comprises a receiving section for accommodating the coupling device at least in sections.

The receiving section can be cylindrical, and in particular tubular. Viewed in a radial direction, the intermediate space is delimited circumferentially by the receiving section. Viewed in the axial direction, the intermediate space is delimited by the end faces.

According to a further embodiment, the cryogenic tank-filling arrangement further comprises an aggregate for generating the pressure change in the intermediate space.

The aggregate can be a vacuum pump. The aggregate is preferably assigned to the coupling device. However, the aggregate can also be assigned to the receptacle.

According to a further embodiment, the cryogenic tank-filling arrangement further comprises a locking device for locking the coupling device in the receptacle as soon as the cryogenic tank-filling arrangement is in the locked state.

According to a further embodiment, the cryogenic tank-filling arrangement further comprises a locking device for locking the coupling device and the receptacle as soon as the cryogenic tank-filling arrangement is in the locked state.

The locking device secures the coupling device in the receptacle, even when the intermediate space is no longer being subjected to the pressure change. The locking device can be controlled in an automated manner. The connection of the coupling device and the receptacle and the disconnection of the coupling device from the receptacle can take place in an automated manner.

According to a further embodiment, the locking device comprises an engagement element and a counter-engagement element in which the engagement element engages in a form-fitting manner in the locked state.

A form-fitting connection is produced by mutual engagement or rearward engagement of the two connecting partners—in the present case, the engagement element and the counter-engagement element. The engagement element can be a pin, for example. The counter-engagement element can be a recess or hole.

According to a further embodiment, the locking device is controlled electrically, electromagnetically, mechanically, pneumatically, or hydraulically.

This enables automated control of the locking device.

Furthermore, a method for operating a cryogenic tank-filling arrangement having a coupling device and a receptacle is proposed. In this case, the coupling device and the receptacle are designed to be complementary to each other. The method comprises the following steps: a) accommodating the coupling device and the receptacle in each other in sections, so that the coupling device and the receptacle enclose an intermediate space which is closed off relative to an environment of the cryogenic tank-filling arrangement and is arranged between an end face of the coupling device and an end face of the receptacle, and b) generating a pressure change in the intermediate space so that the end face of the coupling device is pressed against the end face of the receptacle as a result of the change in pressure.

In a further development, a method for operating such a cryogenic tank-filling arrangement having a coupling device and a receptacle is proposed. The method comprises the steps of: a) accommodating the coupling device in the receptacle in such a way that an intermediate space closed off from an environment of the cryogenic tank-filling arrangement is provided between the coupling device and the receptacle, and b) generating a pressure change in the intermediate space such that the coupling device is pressed against the receptacle as a result of the change in pressure.

In particular, the coupling device is pressed against the receptacle by the force generated with the aid of the pressure change. In step a), the coupling device is inserted into the receptacle by a user. However, insertion goes only to the point where the intermediate space remains between the coupling device and the receptacle. In step b), the cryogenic tank-filling arrangement is brought from the unlocked state into the locked state. In the locked state, the locking of the coupling device on the receptacle initially takes place purely by means of the pressure change or a negative pressure or with the aid of the force generated by the pressure change.

According to one embodiment, after or in step b), the coupling device is electrically, electromagnetically, mechanically, pneumatically, or hydraulically locked by means of a locking device on the receptacle.

According to one embodiment, after or in step b), the coupling device and the receptacle are electrically, electromagnetically, mechanically, pneumatically, or hydraulically locked together with the aid of a locking device.

The locking device can comprise an engagement element assigned to the coupling device and a counter-engagement element assigned to the receptacle. To lock the coupling device to the receptacle, the engagement element engages in the counter-engagement element in a form-fitting manner.

According to a further embodiment, steps a) and b) are carried out in an automated manner.

This enables an automated connection or disconnection of the coupling device to or from the receptacle.

Further possible implementations of the cryogenic tank-filling arrangement and/or of the method also include not explicitly mentioned combinations of features or embodiments described above or below with respect to the exemplary embodiments. A person skilled in the art will also add individual aspects as improvements or additions to the respective basic form of the cryogenic tank-filling arrangement and/or of the method.

Further advantageous embodiments and aspects of the cryogenic tank-filling arrangement and/or of the method are the subject matter of the subclaims and of the exemplary embodiments described below of the cryogenic tank-filling arrangement and/or of the method. The cryogenic tank-filling arrangement and/or the method are explained below in more detail on the basis of preferred embodiments with reference to the enclosed figures.

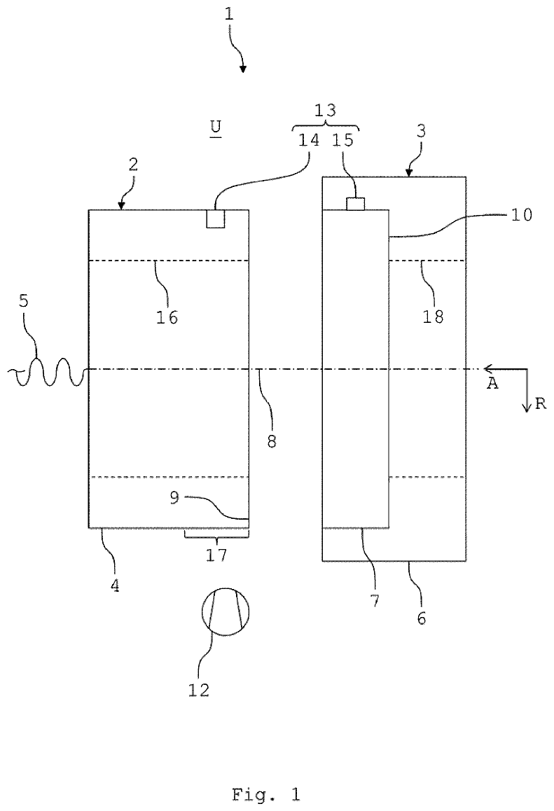

FIG. 1 shows a schematic view of an embodiment of a cryogenic tank-filling arrangement;

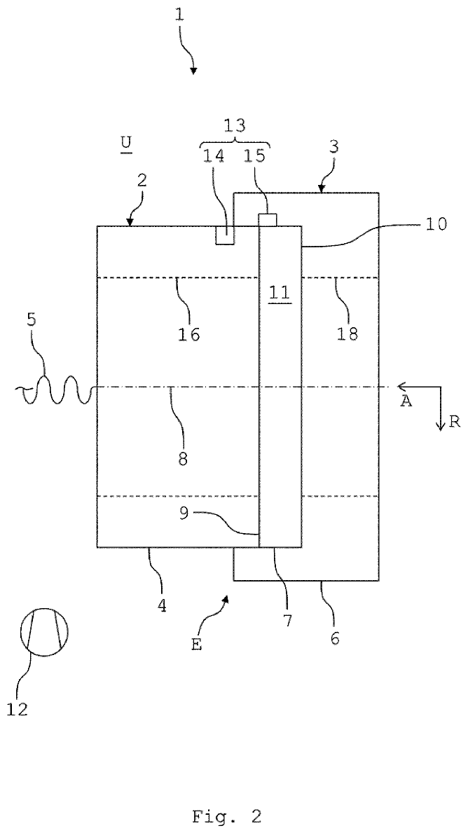

FIG. 2 shows a further schematic view of the cryogenic tank-filling arrangement according to FIG. 1;

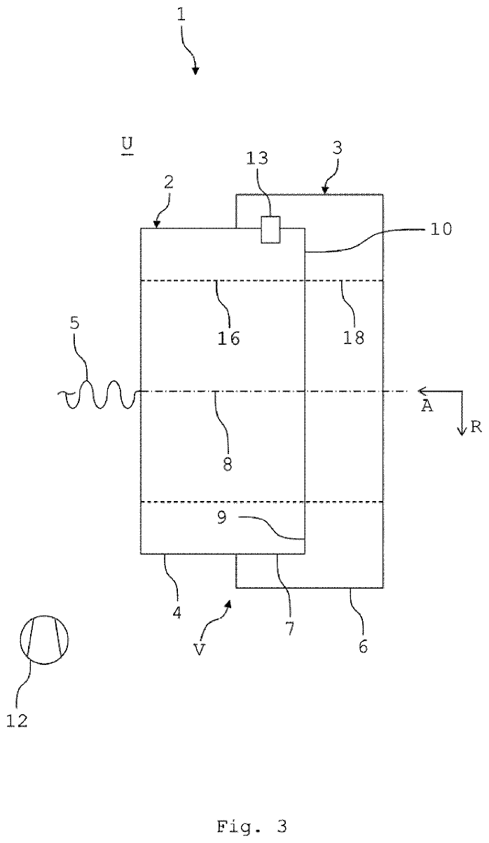

FIG. 3 shows a further schematic view of the cryogenic tank-filling arrangement according to FIG. 1; and

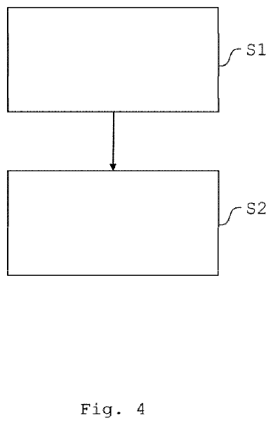

FIG. 4 shows a schematic block diagram of an embodiment of a method for operating the cryogenic tank-filling arrangement according to FIG. 1.

In the figures, the same or functionally equivalent elements have been provided with the same reference signs unless otherwise indicated.

FIG. 1 shows a schematic view of a cryogenic tank-filling arrangement 1. FIGS. 2 and 3 show further schematic views of the cryogenic tank-filling arrangement 1. In the following, reference is made simultaneously to FIGS. 1 through 3.

The cryogenic tank-filling arrangement 1 can also be referred to as a cryogenic refueling arrangement. The cryogenic tank-filling arrangement 1 is suitable for filling a storage tank with a cryogen or a cryogenic medium, for example. The cryogen can, for example, be liquid hydrogen, monosilane, ethylene, or the like.

The cryogenic tank-filling arrangement 1 comprises a coupling device 2 which can be accommodated at least in sections in a receptacle 3. For example, the receptacle 3 can be a tank nozzle. The coupling device 2 and the receptacle 3 are essentially cylindrical. The coupling device 2 comprises a cylindrical housing 4. The coupling device 2 is coupled to a flexible refueling hose 5. The receptacle 3 has a cylindrical housing 6 with a tubular receiving section 7. The receiving section 7 is suitable for accommodating the coupling device 2 therein, at least in sections.

Conversely, the receiving section 7 can also be provided on the coupling device 2, and in particular on the housing 4. In this case, the receptacle 3 can then be accommodated in the coupling device 2. The receiving section 7 can have a cylindrical, and in particular a hollow-cylindrical, geometry.

The cryogenic tank-filling arrangement 1 is assigned a middle axis or axis of symmetry 8. The coupling device 2 and the receptacle 3 can be constructed to be essentially rotationally symmetrical to the axis of symmetry 8. The cryogenic tank-filling arrangement 1 is also assigned an axial direction A, which is oriented along the axis of symmetry 8, and a radial direction R. The radial direction R is oriented to be perpendicular to the axis of symmetry 8 and away from it.

In order to connect the coupling device 2 to the receptacle 3, the coupling device 2, as shown in FIG. 2, is initially inserted into the receiving section 7 up to the point that a gap or intermediate space 11 is provided between an end face 9 of the coupling device 2 and an end face 10 of the receiving section 7. When viewed along the radial direction R, the intermediate space 11 is delimited by the receiving section 7. When viewed along the axial direction A, the intermediate space 11 is delimited by the end faces 9, 10.

The end faces 9, 10 are in each case annular. The end faces 9, 10 can also be referred to as ends. The first end face 9 is assigned to the housing 4 of the coupling device 2. The second end face 10 is assigned to the housing 6 of the receptacle 3.

In this case, the intermediate space 11 is sealed in a fluid-tight manner relative to an environment U of the cryogenic tank-filling arrangement 1. That is to say, when the coupling device 2 is inserted into the receiving section 7, a fluid-tight connection is first established between the coupling device 2 and the receptacle 3 so that the intermediate space 11 is closed off from the environment U. The cryogenic tank-filling arrangement 1 is now in an unlocked state E.

When viewed along the axial direction A, the intermediate space 11 is delimited or defined on both sides by the end faces 9, 10. When viewed along the radial direction R, the intermediate space 11 is delimited or defined by the receiving section 7.

A pressure change, and in particular a pressure reduction, is then generated in the intermediate space 11. In particular, a vacuum is generated in the intermediate space 11. For this purpose, an aggregate 12 is provided for generating the pressure change. The aggregate 12 is a vacuum pump. With the aid of the pressure change in the intermediate space 11, the coupling device 2 and the receptacle 3 are pulled together into a locked state V, shown in FIG. 3, in which the end faces 9, 10 abut each other. The pressure change generates a force acting on the coupling device 2. The cryogenic tank-filling arrangement 1 is now in the locked state V.

Finally, the coupling device 2 and the receptacle 3 are locked together in the locked state V. A locking device 13 is provided for this purpose. The locking device 13 is an electrical, electromagnetic, mechanical, pneumatic, or hydraulic locking device. The locking device 13 can have an engagement element 14 assigned to the coupling device 2, which engagement element is designed, in the locked state V, to engage in a form-fitting manner in a counter-engagement element 15 assigned to the receptacle 3. For example, the engagement element 14 is a displaceably mounted pin. The counter-engagement element 15 can be a corresponding recess.

The disconnection of the coupling device 2 from the receptacle 3 takes place in reverse and is fully automatable, so that, in case of an emergency, the coupling device 2 can be safely unlocked and disconnected from the receptacle 3.

The housing 4 of the coupling device 2 is in particular tubular or hollow-cylindrical and has an inner wall 16 extending completely around the axis of symmetry 8. On the outside of the housing 4, i.e., facing away from the inner wall 16, a counter-receiving section 17 is provided. The counter-receiving section 17 can be accommodated in the receiving section 7. Alternatively, the counter-receiving section 17 can also be provided on the receptacle 3. In this case, the receiving section 7 is then provided on the coupling device 2. The first end face 9 is, seen in the radial direction R, delimited by the inner wall 16 and the counter-receiving section 17. This results in the annular shape of the first end face 9.

The coupling device 2—in particular, its counter-receiving section 17—and the receptacle 3—in particular, its receiving section 7—are designed to be complementary to each other. In this context, “complementary” means in particular that the coupling device 2—in particular, the counter-receiving section 17—and the receptacle 3—in particular, the receiving section 7—can be plugged into each other according to a plug-socket principle. In this case, either the coupling device 2 can be plugged into the receptacle 3 or, conversely, the receptacle 3 can be plugged into the coupling device 2.

This can be achieved by a suitable geometry of the receiving section 7 and of the counter-receiving section 17. For example, the receiving section 7 and the counter-receiving section 17 are in each case cylindrical, and in particular hollow-cylindrical, and can thus be plugged into each other. In cross-section, the receiving section 7 and the counter-receiving section 17 can also in each case have a polygonal—in particular, hexagonal—or a star-shaped geometry.

The housing 6 of the receptacle 3 is, in particular, likewise tubular or hollow-cylindrical and has an inner wall 18 extending completely around the axis of symmetry 8. The inner wall 18 can have a smaller diameter than the receiving section 7. The receiving section 7 can be an inner wall which extends completely around the axis of symmetry 8 and is cylindrical. The receiving section 7 can thus be rotationally symmetrical with respect to the axis of symmetry 8. Likewise, the counter-receiving section 17 can be rotationally symmetrical with respect to the axis of symmetry 8.

FIG. 4 shows a schematic block diagram of an embodiment of a method for producing the cryogenic tank-filling arrangement 1. In a step S1, the coupling device 2 is accommodated in the receptacle 3 in such a way that, between the coupling device 2 and the receptacle 3, the intermediate space 11 closed off from the environment U of the cryogenic tank-filling arrangement 1 is provided. Conversely, in step S1, the receptacle 3 can also be accommodated in the coupling device 2. The cryogenic tank-filling arrangement 1 is now in the unlocked state E.

In a step S2, a pressure change, and in particular a pressure reduction, is generated in the intermediate space 11, so that the coupling device 2 is pressed against the receptacle 3 due to pressure. In particular, a vacuum is generated in the intermediate space 11. In particular, the end faces 9, 10 are pressed against each other. The coupling device 2 is pulled into the receptacle 3. After or in step S2, the coupling device 2 is locked on the receptacle 3 electrically, electromagnetically, mechanically, pneumatically, or hydraulically with the aid of the locking device 13. Steps S1, S2 can be carried out automatically.

Although the present invention has been described with reference to exemplary embodiments, it can be modified in many ways within the scope of the claims.

### REFERENCE SIGNS USED

1 Cryogenic tank-filling arrangement
2 Coupling device
3 Receptacle
4 Housing
5 Refueling hose
6 Housing
7 Receiving section
8 Axis of symmetry
9 End face
10 End face
11 Intermediate space
12 Aggregate
13 Locking device
14 Engagement element
15 Counter-engagement element
16 Inner wall
17 Counter-receiving section
18 Inner wall
A Axial direction
E Unlocked state
R Radial direction
S1 Step
S2 Step
U Environment
V Locked state

1. A cryogenic tank-filling arrangement having a coupling device and a receptacle, wherein the coupling device and the receptacle are designed to be complementary to each other, wherein the cryogenic tank-filling arrangement can be brought from an unlocked state—in which the coupling device and the receptacle are accommodated in each other at least in sections, so that the coupling device and the receptacle enclose an intermediate space which is closed off relative to an environment of the cryogenic tank-filling arrangement and which is arranged between an end face of the coupling device and an end face of the receptacle—into a locked state by means of a pressure change in the intermediate space, in which locked state the end face of the coupling device is pressed against the end face of the receptacle due to the pressure change.

2. The cryogenic tank-filling arrangement according to claim 1, wherein the coupling device has a counter-receiving section, wherein the receptacle has a receiving section complementary to the counter-receiving section, and wherein the counter-receiving section is accommodated in the receiving section not only in the unlocked state but also in the locked state at least in sections.

3. The cryogenic tank-filling arrangement according to claim 2, wherein the counter-receiving section and the receiving section are in each case cylindrical.

4. The cryogenic tank-filling arrangement according to claim 1, wherein the first end face and the second end face are in each case annular.

5. The cryogenic tank-filling arrangement according to claim 1, wherein the first end face is provided on a housing of the coupling device, and wherein the second end face is provided on a housing of the receptacle.

6. The cryogenic tank-filling arrangement according to claim 1, further comprising an aggregate for generating the pressure change in the intermediate space.

7. The cryogenic tank-filling arrangement according to claim 1, further comprising a locking device for locking the coupling device and the receptacle as soon as the cryogenic tank-filling arrangement is in the locked state.

8. The cryogenic tank-filling arrangement according to claim 7, wherein the locking device comprises an engagement element and a counter-engagement element into which the engagement element engages in a form-fitting manner in the locked state.

9. The cryogenic tank-filling arrangement according to claim 7, wherein the locking device is controlled electrically, electromagnetically, mechanically, pneumatically, or hydraulically.

10. A method for operating a cryogenic tank-filling arrangement having a coupling device and a receptacle, wherein the coupling device and the receptacle are complementary to each other, with the following steps:
a) accommodating the coupling device and the receptacle in each other in sections, so that the coupling device and the receptacle enclose an intermediate space which is closed off relative to an environment of the cryogenic tank-filling arrangement and is arranged between an end face of the coupling device and an end face of the receptacle, and
b) generating a pressure change in the intermediate space, so that the end face of the coupling device is pressed against the end face of the receptacle due to the pressure change.

11. The method according to claim 10, wherein, after or in step b), the coupling device and the receptacle are locked to each other electrically, electromagnetically, mechanically, pneumatically, or hydraulically with the aid of a locking device.

12. The method according to claim 10, wherein steps a) and b) are carried out in an automated manner.
